(19) United States
(12) Patent Application Publication
(10) Pub. No.: US 2022/0173452 A1
(43) Pub. Date: Jun. 2, 2022

(54) METHOD OF INJECTING THERMAL ADHESIVE IN HIGH-VOLTAGE BATTERIES

(71) Applicant: GM GLOBAL TECHNOLOGY OPERATIONS LLC, Detroit, MI (US)

(72) Inventors: Timothy J. HOWE, Canton, MI (US); Davis DAY, Commerce Township, MI (US); Jared R. GOHLKE, Janesvilles, WI (US)

(21) Appl. No.: 17/109,226

(22) Filed: Dec. 2, 2020

(51) Int. Cl. H01M 10/653; H01M 10/613; H01M 10/625; H01M 10/04; H01M 10/6555; H01M 50/204; H01M 50/249

(52) U.S. Cl. CPC H01M 10/653; H01M 10/613; H01M 10/625; H01M 2220/20; H01M 10/6555; H01M 50/204; H01M 50/249; H01M 10/0413

(57) ABSTRACT

A battery comprising a housing including a top plate and a bottom plate. The battery comprises a first battery cell stack comprising a first plurality of battery cells; a second battery cell stack comprising a second plurality of battery cells; a cold plate inserted between the first and second battery cell stacks, the cold plate in contact with the top plate and the bottom plate of the housing; and iv) a thermal adhesive injected into a first region between the cold plate and the first battery cell stack and substantially filling the first region.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to multi-cell battery assemblies for electric vehicles and hybrid electric vehicles. Vehicle batteries generate heat and undergo mechanical stress from vehicle vibrations and movements. Thermal adhesives hold together multiple cells within a battery assembly and dissipate the generated heat. Conventionally, a multi-axis robotic machine dispenses a thermal adhesive onto a flat surface. Next, force is applied between the heat generating and heat extracting components to reject excess heating of critical components. The cell groupings may require retention by alternate methods when an assembly system does not clamp with enough force and only limited friction is available. As a result, battery module thermal joints may require bonding strength to withstand loads generated from vehicle events.

### SUMMARY

It is an object of the present disclosure to provide a battery comprising: i) a housing comprising a top plate and a bottom plate; ii) a first battery cell stack comprising a first plurality of battery cells arranged in a stack; ii) a second battery cell stack comprising a second plurality of battery cells arranged in a stack; iii) a cold plate inserted between the first and second battery cell stacks, the cold plate in contact with the top plate and the bottom plate of the housing; and iv) a thermal adhesive injected into a first region between the cold plate and the first battery cell stack and substantially filling the first region.

In one embodiment, a volume of the thermal adhesive injected into the first region is substantially equal to a calculated volume of the first region.

In another embodiment, the thermal adhesive injected into the first region is injected into the first region until the thermal adhesive overflows a hole in the housing of the battery.

In still another embodiment, the hole in the housing of the battery is located in the top plate.

In yet another embodiment, the thermal adhesive is injected into the first region through a hole in the top plate.

In a further embodiment, the thermal adhesive is further injected into a second region between the cold plate and the second battery cell stack and substantially fills the second region.

In a still further embodiment, a volume of the thermal adhesive injected into the second region is substantially equal to a calculated volume of the second region.

In a yet further embodiment, the thermal adhesive injected into the second region is injected into the second region until the thermal adhesive overflows a hole in the housing of the battery.

It is another object of the present disclosure to provide a method of manufacturing a battery comprising a housing including a top plate and a bottom plate. The method comprises: i) arranging in the housing a first plurality of battery cells in a first battery cell stack; ii) arranging in the housing a second plurality of battery cells in a second battery cell stack; iii) inserting a cold plate between the first and second battery cell stacks, the cold plate in contact with the top plate and the bottom plate when the top plate and the bottom plate are attached to the housing; and iv) injecting a thermal adhesive into a first region between the cold plate and the first battery cell stack and substantially filling the first region.

In one embodiment, a volume of the thermal adhesive injected into the first region is substantially equal to a calculated volume of the first region.

In another embodiment, the thermal adhesive injected into the first region is injected into the first region until the thermal adhesive overflows a hole in the housing of the battery.

In still another embodiment, the hole in the housing of the battery is located in the top plate.

In yet another embodiment, the thermal adhesive is injected into the first region through a hole in the top plate.

In a further embodiment, the method further comprises injecting the thermal adhesive into a second region between the cold plate and the second battery cell stack and substantially filling the second region.

In a still further embodiment, a volume of the thermal adhesive injected into the second region is substantially equal to a calculated volume of the second region.

In a yet further embodiment, the thermal adhesive injected into the second region is injected into the second region until the thermal adhesive overflows a hole in the housing of the battery.

Further areas of applicability of the present disclosure will become apparent from the detailed description, the claims and the drawings. The detailed description and specific examples are intended for purposes of illustration only and are not intended to limit the scope of the disclosure.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an exemplary vehicle system that includes a battery using injected thermal adhesive according to an embodiment of the present disclosure.

FIG. 2 is a cross-sectional view of a portion of the interior of a battery using dispensed thermal adhesive according to a conventional process.

FIG. 3 is a cross-sectional view of a portion of the interior of the improved battery using injected thermal adhesive according to an embodiment of the present disclosure.

FIG. 4 is a flow diagram illustrating the assembly process of a battery using injected thermal adhesive according to an embodiment of the present disclosure.

In the drawings, reference numbers may be reused to identify similar and/or identical elements.

### DETAILED DESCRIPTION

The present disclosure describes a multi-cell vehicle battery using thermal adhesives that are injected into the housing of the battery after the battery cells are assembled. Injectable thermal adhesives have the ability to reduce assembly complexity constraints related to the order of operations in a manufacturing assembly process. The injection process may use specific viscosities to move the injected material into compact available spaces. The injection process eliminated problems related to contact coverage variation between module assemblies. Advantageously, cells disposed near a cold plate do not require force during installation.

The injected adhesive does not require a seal compared to conventional processes and provides thermal and structural solutions for edge-cooled battery pouch cells with limited physical access. Edge-cooled cells require maximum cooling capabilities given the geometrical constraints of the battery body. An injectable adhesive allows maximum contact between battery cells and the cooling plate.

The disclosed battery and method of fabricating a battery provides numerous advantages. The thermal adhesive has multi-level viscosity to allow injection and has the correct cured material properties to withstand internal and external loads. The battery housing includes holes at the top and bottom near the gap between the cold plate and the cells to allow injection. In addition, the system of components in the battery assembly can slow or stop flow of the injected adhesive in undesired directions.

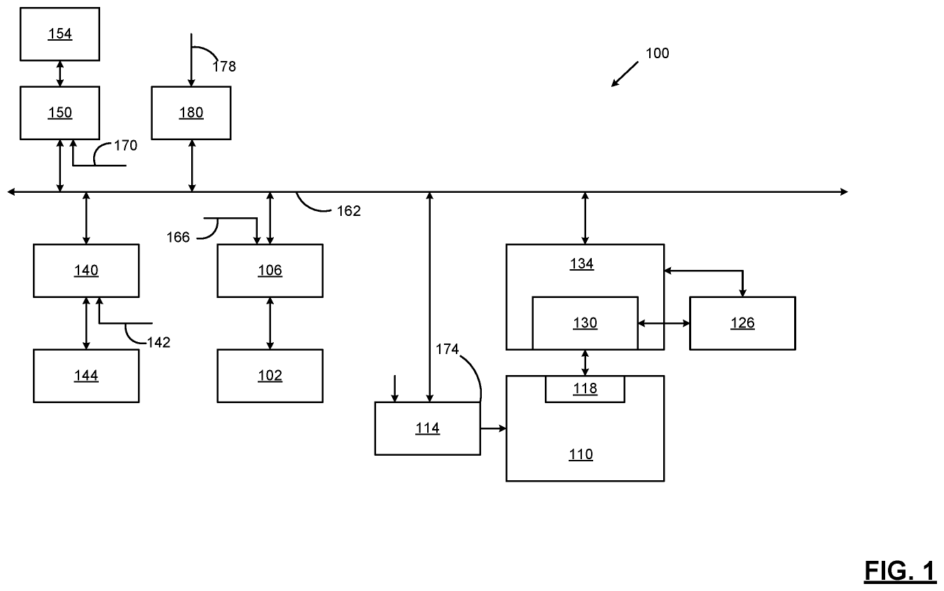

FIG. 1 is a functional block diagram of an exemplary vehicle system 100 that includes a battery 126 using injected thermal adhesive according to an embodiment of the present disclosure. While a vehicle system for a manually driven hybrid vehicle is shown and described, the present disclosure is also applicable to autonomously driven vehicles and to all-electric vehicles that include a battery using injected thermal adhesive. The present application may also be applicable to non-automobile implementations, such as trains, boats and aircraft.

An engine 102 combusts an air/fuel mixture to generate drive torque. An engine control module (ECM) 106 controls the engine 102 based on one or more driver or vehicle inputs. For example, the ECM 106 may control actuation of engine actuators, such as a throttle valve, one or more spark plugs, one or more fuel injectors, valve actuators, camshaft phasers, an exhaust gas recirculation (EGR) valve, one or more boost devices, and other suitable engine actuators.

The engine 102 may output torque to a transmission 110. A transmission control module (TCM) 114 controls operation of the transmission 110. For example, the TCM 114 may control gear selection within the transmission 110 and one or more torque transfer devices (e.g., a torque converter, one or more clutches, etc.).

The vehicle system 100 may include one or more electric motors. For example, an electric motor 118 may be implemented within the transmission 110 as shown in the example of FIG. 1A. An electric motor can act either as a generator or as a motor at a given time. When acting as a generator, an electric motor converts mechanical energy into electrical energy. The electrical energy may charge a battery 126 via a power control device (PCD) 130. When acting as a motor, an electric motor generates torque that supplements or replaces torque output by the engine 102. While the example of one electric motor is provided, the vehicle may include zero or more than one electric motor.

A power inverter control module (PIM) 134 may control the electric motor 118 and the PCD 130. The PCD 130 applies (e.g., direct current) power from the battery 126 to the (e.g., alternating current) electric motor 118 based on signals from the PIM 134, and the PCD 130 provides power output by the electric motor 118, for example, to the battery 126. The PIM 134 may be referred to as a power inverter module (PIM) in various implementations.

A steering control module 140 controls steering/turning of wheels of the vehicle, for example, based on driver turning of a steering wheel within the vehicle and/or steering commands from one or more vehicle control modules. A steering wheel angle sensor (SWA) monitors rotational position of the steering wheel and generates a SWA 142 signal based on the position of the steering wheel. As an example, the steering control module 140 may control vehicle steering via an EPS motor 144 based on the SWA 142 signal. However, the vehicle may include another type of steering system. An electronic brake control module (EBCM) 150 may selectively control brakes 154 of the vehicle.

Modules of the vehicle may share parameters via a controller area network (CAN) 162. The CAN 162 may also be referred to as a car area network. For example, the CAN 162 may include one or more data buses. Various parameters may be made available by a given control module to other control modules via the CAN 162.

The driver inputs may include, for example, an accelerator pedal position (APP) 166 which may be provided to the ECM 106. A brake pedal position (BPP) 170 may be provided to the EBCM 150. A position 174 of a park, reverse, neutral, drive lever (PRNDL) may be provided to the TCM 114. An ignition state 178 may be provided to a body control module (BCM) 180. For example, the ignition state 178 may be input by a driver via an ignition key, button, or switch. At a given time, the ignition state 178 may be one of off, accessory, run, or crank.

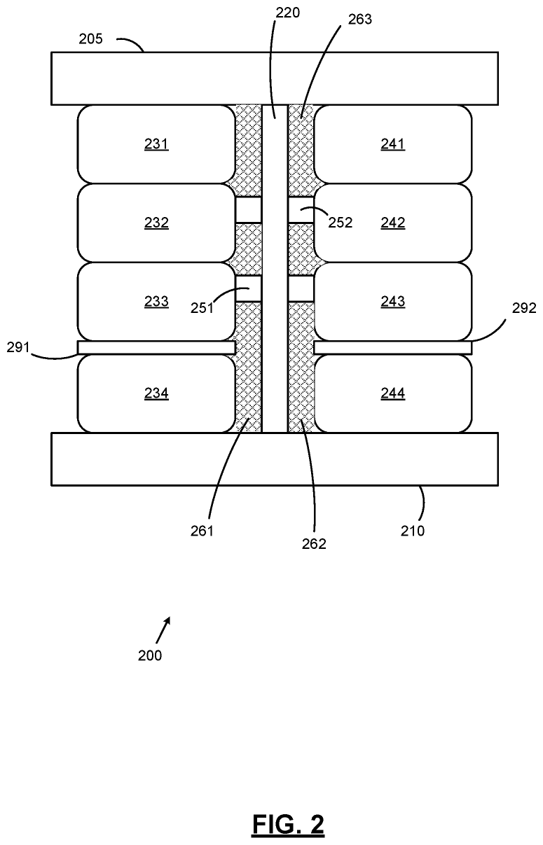

FIG. 2 is a cross-sectional view of a portion of the interior of a battery 200 using dispensed thermal adhesive according to a conventional process. Battery 200 comprises a top plate 205, a bottom plate 210, a cold plate 220, and a plurality of battery cells, including cells 231-234 and cells 241-244. The insulation layer 291 separates the cell 233 and the cell 234 and the insulation layer 291 separates the cell 243 and the cell 244. The insulation layers 291 and 292 provide protection from large vehicle vibrations and shocks. Other portions of the battery 200, such as sidewalls and wiring, are not shown in order to simplify the description of the battery 200.

Cold plate 220 absorbs heat from the cells 231-234 and 241-244 and conducts the heat to the top plate 205 and the bottom plate 210. Cells 231-234 are disposed on one side of the cold plate 220 and cells 241-244 are disposed on the other side of the cold plate 220. During a conventional process for assembling the battery 200, thermal adhesive is dispensed on the top surfaces of each cell 231-234 and each of cells 241-244, the cells 231-234 and 241-244 are stacked as shown, and the cells 231-234 and 241-244 are pressed together between the top plate 205 and the bottom plate 210. The cold plate 220 is inserted between the stacks of the cells 231-234 and 241-244 and the thermal adhesive is forced into the space between the cold plate 220 and the stacks of the cells 231-234 and 241-244.

However, this method of assembling the battery 200 may result in ineffective distribution of the thermal adhesive. In FIG. 2, the exemplary regions 261-263 are filled with thermal adhesive, as indicated by the cross-hatched shading. However, a plurality of voids, including exemplary voids 251 and 252, are also created in the spaces between the cold plate 220 and the stacks of the cells 231-234 and 241-244. These voids prevent effective transfer of heat from the cells 231-234 and 241-244 to the cold plate 220 and weaken the bonding of the entire battery assembly.

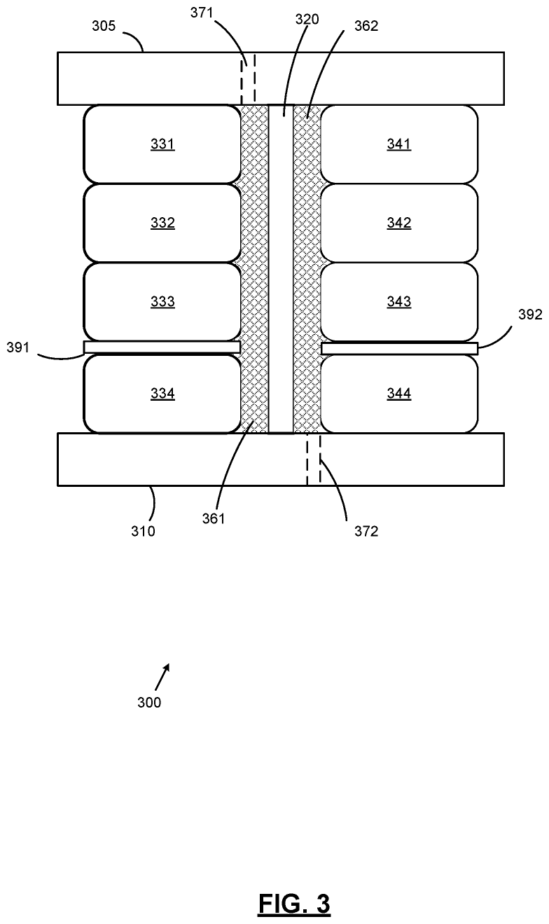

FIG. 3 is a cross-sectional view of a portion of the interior of the improved battery 300 using injected thermal adhesive according to an embodiment of the present disclosure. The battery 300 comprises a top plate 305, a bottom plate 310, a cold plate 320, and a plurality of battery cells, including the cells 331-334 and the cells 341-344. The insulation layer 391 separates the cell 333 and the cell 334 and the insulation layer 391 separates the cell 343 and the cell 344. The insulation (or padding) layers 391 and 392 provide protection from large vehicle vibrations and shocks. Other portions of the battery 300, such as sidewalls and wiring, are not shown in order to simplify the description of the disclosed battery 300. The cold plate 320 absorbs heat from the cells 331-334 and 341-344 and conducts the heat to the top plate 305 and the bottom plate 310. The cells 331-334 are disposed on one side of the cold plate 320 and the cells 341-344 are disposed on the other side of the cold plate 320.

According to the principles of the present disclosure, an improved assembly process injects thermal adhesive into the spaces between the cold plate 320 and the stacks of the cells 331-334 and 341-344 after the other components of the battery 300 have been assembled. Thus, the cells 331-334 and 341-344 are first stacked in the housing of the battery 300 and are pressed together between the top plate 305 and the bottom plate 310. The cold plate 320 is then inserted between the stacks of the cells 331-334 and 341-344.

Finally, the thermal adhesive is injected into the spaces between the cold plate 320 and the stacks of the cells 331-334 and 341-344. A hole 371 in the top plate 305 may be used to inject the thermal adhesive. A hole 372 in the bottom plate 310 also may be used to inject the thermal adhesive. In this manner, the regions 361 and 362 between the cold plate 320 and the stacks of the cells 331-334 and 341-344 are completely filled with thermal adhesive, as indicated by the cross-hatched shading.

The regions 361 and 362 may be precisely filled by calculating the precise volume of the regions 361 and 362 and injected an amount of thermal adhesive equivalent to the calculated volume into the hole 371 or the hole 372, or both, if holes 371 and 372 are both present. One or both of the top plate 305 and the bottom plate 310 may contain additional vent holes (not shown) to allow air to escape from the regions 361 and 362 as the injected thermal adhesive fills the regions 361 and 362. In an advantageous embodiment, the thermal adhesive may be injected into the hole 372 and the hole 371 then acts as a vent hole for air as the regions 361 and 362 fill with the thermal adhesive. Alternatively, the regions 361 and 362 may be precisely filled by injecting the thermal adhesive into one of the holes 371 or 372 until the thermal adhesive begins to leak out of the other one of the holes 371 or 372.

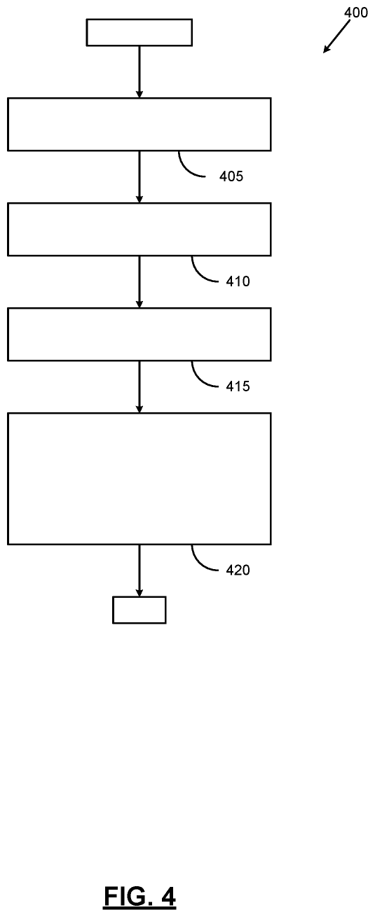

FIG. 4 is a flow diagram 400 illustrating the assembly process of the battery 300 using injected thermal adhesive according to an embodiment of the present disclosure. In 405, the manufacturing process assembles a plurality of stacks of battery cells (as shown in FIG. 3) on top of the bottom plate 310 in the housing of battery 300. Insulation or padding optionally may be inserted between battery cells in the same stack to reduce vibrations and shock. A space exists between the stacks of battery cells. In 410, the manufacturing process inserts one or more cold plates 320 into the space between the stacks of battery cells.

Once all stacks of battery cells and cold plates are in place, the manufacturing process in 415 securely closes the top plate 305 on the battery housing, thereby pressing the stacks of battery cells together and providing a good thermal contact between the cold plate(s) 320 and the top plate 305 and the bottom plate 310. Next, in 420, the manufacturing process injects thermal adhesive through the hole 371 and/or the hole 371 into regions 361 and 362. The volume of the regions 361 and 362 may be precisely calculated. Thus, in one embodiment, the thermal adhesive may be injected until the volume of the adhesive equals the calculated volume of the regions 361 and 362. Alternatively, the thermal adhesive may be injected until the injected adhesive overflows the hole 371 in the top plate 305 or another vent hole disposed either on the top plate 305 or near the upper portion of the battery housing.

Once the regions 361 and 362 are completely filled without voids and the adhesive has hardened, the battery will have improved thermal transfer with increased surface area contact between the cells and the cold plate 320. Advantageously, the disclosed manufacturing process does not require multi-axis robotic machines to locate and dispense a bead of adhesive on a path. The manufacturing process also does not rely on a bead diameter variation during production. The method provides a quicker and easier thermal adhesive assembly process and allows the order of operations to change in module assembly process.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure. It should also be understood that steps in the embodiments can also be eliminated.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A battery comprising:
a housing comprising a top plate and a bottom plate;
a first battery cell stack comprising a first plurality of battery cells arranged in a stack;
a second battery cell stack comprising a second plurality of battery cells arranged in a stack;
a cold plate inserted between the first and second battery cell stacks, the cold plate in contact with the top plate and the bottom plate of the housing; and
a thermal adhesive injected into a first region between the cold plate and the first battery cell stack and substantially filling the first region.

2. The battery of claim 1, wherein a volume of the thermal adhesive injected into the first region is substantially equal to a calculated volume of the first region.

3. The battery of claim 1, wherein the thermal adhesive injected into the first region is injected into the first region until the thermal adhesive overflows a hole in the housing of the battery.

4. The battery of claim 3, wherein the hole in the housing of the battery is located in the top plate.

5. The battery of claim 1, wherein the thermal adhesive is injected into the first region through a hole in the top plate.

6. The battery of claim 1, wherein the thermal adhesive is further injected into a second region between the cold plate and the second battery cell stack and substantially fills the second region.

7. The battery of claim 6, wherein a volume of the thermal adhesive injected into the second region is substantially equal to a calculated volume of the second region.

8. The battery of claim 6, wherein the thermal adhesive injected into the second region is injected into the second region until the thermal adhesive overflows a hole in the housing of the battery.

9. The battery of claim 8, wherein the hole in the housing of the battery is located in the top plate.

10. The battery of claim 6, wherein the thermal adhesive is injected into the second region through a hole in the top plate.

11. A method of manufacturing a battery comprising a housing including a top plate and a bottom plate, the method comprising;
arranging in the housing a first plurality of battery cells in a first battery cell stack;
arranging in the housing a second plurality of battery cells in a second battery cell stack;
inserting a cold plate between the first and second battery cell stacks, the cold plate in contact with the top plate and the bottom plate when the top plate and the bottom plate are attached to the housing; and
injecting a thermal adhesive into a first region between the cold plate and the first battery cell stack and substantially filling the first region.

12. The method of claim 11, wherein a volume of the thermal adhesive injected into the first region is substantially equal to a calculated volume of the first region.

13. The method of claim 11, wherein the thermal adhesive injected into the first region is injected into the first region until the thermal adhesive overflows a hole in the housing of the battery.

14. The method of claim 13, wherein the hole in the housing of the battery is located in the top plate.

15. The method of claim 11, wherein the thermal adhesive is injected into the first region through a hole in the top plate.

16. The method of claim 11, further comprising:
injecting the thermal adhesive into a second region between the cold plate and the second battery cell stack and substantially filling the second region.

17. The method of claim 16, wherein a volume of the thermal adhesive injected into the second region is substantially equal to a calculated volume of the second region.

18. The method of claim 16, wherein the thermal adhesive injected into the second region is injected into the second region until the thermal adhesive overflows a hole in the housing of the battery.

19. The method of claim 18, wherein the hole in the housing of the battery is located in the top plate.

20. The method of claim 16, wherein the thermal adhesive is injected into the second region through a hole in the top plate.
